(19) United States
(12) Patent Application Publication
(10) Pub. No.: US 2025/0207647 A1
(43) Pub. Date: Jun. 26, 2025

(54) BRAKE ACTUATOR AND BRAKE APPARATUS INCLUDING THE SAME

(71) Applicant: HYUNDAI MOBIS CO., LTD., Seoul (KR)

(72) Inventors: Choong Sik SHIN, Yongin-si (KR); Sang Pil BOO, Yongin-si (KR); Chang Hun PARK, Yongin-si (KR)

(73) Assignee: HYUNDAI MOBIS CO., LTD., Seoul (KR)

(21) Appl. No.: 18/634,283

(22) Filed: Apr. 12, 2024

(30) Foreign Application Priority Data
Dec. 22, 2023 (KR) 10-2023-0189870

(51) Int. Cl. F16D 65/18; B60T 13/74; F16D 55/226; F16D 121/24; F16D 125/24; F16D 125/40; F16D 125/48; F16D 125/58; F16D 127/02; F16D 127/06

(52) U.S. Cl. CPC F16D 65/18; B60T 13/746; F16D 55/226; F16D 2121/24; F16D 2125/24; F16D 2125/40; F16D 2125/48; F16D 2125/582; F16D 2127/02; F16D 2127/06

(57) ABSTRACT

Disclosed herein are a brake actuator and a brake apparatus including the same. The brake actuator includes a casing, a first motor installed in the casing, a transmission gear rotatably installed in the casing and connected to the first motor, a first parking member configured to rotate together with the transmission gear, a second motor spaced apart from the first motor, a second parking member rotatably installed in the casing and configured to selectively limit rotation of the first parking member depending on the direction of rotation thereof, and a conversion member configured to convert rotational force of the second motor into linear motion to rotate the second parking member.

### CROSS-REFERENCE TO RELATED APPLICATION

This application claims priority from and the benefit of Korean Patent Application No. 10-2023-0189870, filed on Dec. 22, 2023, which is hereby incorporated by reference for all purposes as if set forth herein.

### BACKGROUND

### Technical Field

Exemplary embodiments of the present disclosure relate to a brake actuator and a brake apparatus including the same, and more particularly, to a brake actuator and a brake apparatus including the same, which are capable of ensuring stable parking braking performance.

### Discussion of the Background

A vehicle brake apparatus generally serves to brake a vehicle by pushing a piston with driving force to bring a pad into close contact with a disc and thus using frictional force between the pad and the disc.

Among others, an electro mechanical brake (EMB) is to generate braking force by mounting a motor-driven actuator directly to a caliper without using hydraulic pressure and pressing a piston through mechanisms such as gears and screws. Such an EMB is capable of performing active braking and wheel-specific independent braking, enabling implementation of additional functions such as ABS, ESC, TCS, and AEB as well as of typical main braking. The EMB is also able to achieve higher performance because there is no delay of hydraulic transmission.

A conventional EMB ensures fast piston response and high efficiency through ball screws. However, these ball screws are impossible, due to the structural characteristics thereof, in self-locking that is allowed to limit their own rotation. Hence, if supply of power to motors is interrupted, braking force may be arbitrarily released by repulsive force between a pad and a piston.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments are directed to a brake actuator and a brake apparatus including the same, which are capable of ensuring stable parking braking performance.

In an embodiment, a brake actuator includes a casing, a first motor installed in the casing, a transmission gear rotatably installed in the casing and connected to the first motor, a first parking member configured to rotate together with the transmission gear, a second motor spaced apart from the first motor, a second parking member rotatably installed in the casing and configured to selectively limit rotation of the first parking member depending on a direction of rotation of the first parking member, and a conversion member configured to convert rotational force of the second motor into linear motion to rotate the second parking member.

The first parking member may include a first parking body connected to a first output shaft of the first motor, and a plurality of extension parts extending from the first parking body and arranged along a circumferential surface of the first parking body.

Each of the extension parts may extend obliquely in relation to a radial direction of the first parking body.

The second parking member may include a second parking body installed to be rotatable about a rotary shaft parallel to the first output shaft, a lever extending from one side of the second parking body and configured to convert the linear motion of the conversion member into rotational motion of the second parking body, and a latching part extending from another side of the second parking body and selectively inserted between a pair of neighboring extension parts as the second parking body rotates in a first direction of rotation.

The conversion member may include a first conversion gear connected to and rotating together with a second output shaft of the second motor, and a second conversion gear connected to the first conversion gear, installed to be linearly movable in a first direction or a second direction opposite to the first direction, and configured to press or releases the lever. The second parking body may rotate in the first direction of rotation as the second conversion gear presses the lever in the first direction.

The first output shaft may be misaligned with the second output shaft.

The first conversion gear may be a pinion gear, and the second conversion gear may be a rack gear.

The brake actuator may further include a return member connected to the lever and configured to press the lever in the second direction.

The return member may be disposed to face the second conversion gear with the lever interposed therebetween.

The return member may be configured to be elastically deformable in a direction parallel to the second direction.

The return member may be a compression spring.

The second parking body may be installed to be movable in a longitudinal direction of the rotary shaft. When a load acting between an associated one of the extension parts and the latching part increases beyond a set magnitude, the second parking body may be moved in a direction of departure parallel to the longitudinal direction of the rotary shaft such that the latching part is separated from the one of the extension parts.

The latching part may have a side surface inclined in relation to the longitudinal direction of the rotary shaft.

The brake actuator may further include a restoration member configured to press the second parking body in a direction opposite to the direction of departure.

The restoration member may include a restoration body disposed to face the second parking body, and an elastic member configured to be elastically deformable in a direction parallel to the longitudinal direction of the rotary shaft, and having two ends that are in contact with the restoration body and the second parking body, respectively.

The elastic member may be a compression spring.

In another embodiment, a brake apparatus includes a caliper body, a piston unit movably installed on the caliper body, and configured to come into contact with or separate from a brake pad depending on a direction of movement of the piston unit, and a brake actuator connected to the piston unit and configured to move the piston unit. The brake actuator includes a casing, a first motor installed in the casing, a transmission gear rotatably installed in the casing and connected to the first motor, a first parking member configured to rotate together with the transmission gear, a second motor spaced apart from the first motor, a second parking member rotatably installed in the casing and configured to selectively limit rotation of the first parking member depending on a direction of rotation of the first parking member, and a conversion member configured to convert rotational force of the second motor into linear motion to rotate the second parking member.

As apparent from the above description, the brake actuator and brake apparatus according to the present disclosure can maintain parking braking force even if the operation of the first motor is released during parking braking by the first parking member and the second parking member.

The brake actuator and brake apparatus according to the present disclosure can ensure the freedom of design in placement of the second motor by indirectly connecting the second parking member to the second motor via the conversion member.

The brake actuator and brake apparatus according to the present disclosure can return the second parking body to its initial position without driving the second motor by the return member, thereby controlling the operation of the second parking body only by the ON/OFF control of the second motor.

The brake actuator and brake apparatus according to the present disclosure can prevent the vehicle from losing its driving ability by forcibly releasing the braking force by the inclined structure of the latching part and the extension part and the restoration member when the braking force is not smoothly released due to damage or malfunction of the first and second parking members.

### BRIEF DESCRIPTION OF THE DRAWINGS

FIG. 1 is a perspective view schematically illustrating a configuration of a brake apparatus according to an embodiment of the present disclosure.

FIG. 2 is a cross-sectional view schematically illustrating the configuration of the brake apparatus according to the embodiment of the present disclosure.

FIG. 3 is a perspective view schematically illustrating a configuration of a brake actuator according to the embodiment of the present disclosure.

FIG. 4 is a front view schematically illustrating the configuration of the brake actuator according to the embodiment of the present disclosure.

FIG. 5 is a perspective view schematically illustrating a configuration of a first parking member, a second parking member, and a conversion member according to the embodiment of the present disclosure.

FIG. 6 is a front view schematically illustrating the configuration of the first parking member, the second parking member, and the conversion member according to the embodiment of the present disclosure.

FIGS. 7, 8, and 9 are views schematically illustrating a process of generating parking braking force.

FIGS. 10, 11, and 12 are views schematically illustrating a process of releasing parking braking force.

FIGS. 13, 14, and 15 are views schematically illustrating a process of forcibly releasing parking braking force.

### DETAILED DESCRIPTION OF THE ILLUSTRATED EMBODIMENTS

Exemplary embodiments of the present disclosure will be described below with reference to the accompanying drawings.

It should be considered that the thickness of each line or the size of each component in the drawings may be exaggeratedly illustrated for clarity and convenience of description. In addition, the terms used herein are terms defined in consideration of functions of the present disclosure, and these terms may change depending on the intention or practice of a user or an operator. Therefore, these terms should be defined based on the entirety of the disclosure set forth herein.

In the specification, it will be understood that when an element is referred to as being “connected (or joined)” to another element, it can be “directly connected (or joined)” to the other element or it can be “indirectly connected (or joined)” to the other element with other elements being interposed therebetween. In the specification, it will be understood that when a component is referred to as “comprising (or including)” any component, it does not exclude other components, but can further comprise (or include) the other components unless otherwise specified.

Throughout the specification, like reference numerals may refer to like components. Even if the same or similar reference numerals are not mentioned or described in a particular drawing, they may be described based on other drawings. In addition, even if there is an element that is not marked with a reference numeral in a specific drawing, that element may be described based on other drawings. Moreover, the number, shape, size, relative difference, and the like of the detailed components represented in the drawings herein are set for convenience of understanding, and may be implemented in various forms without limiting the embodiments thereof.

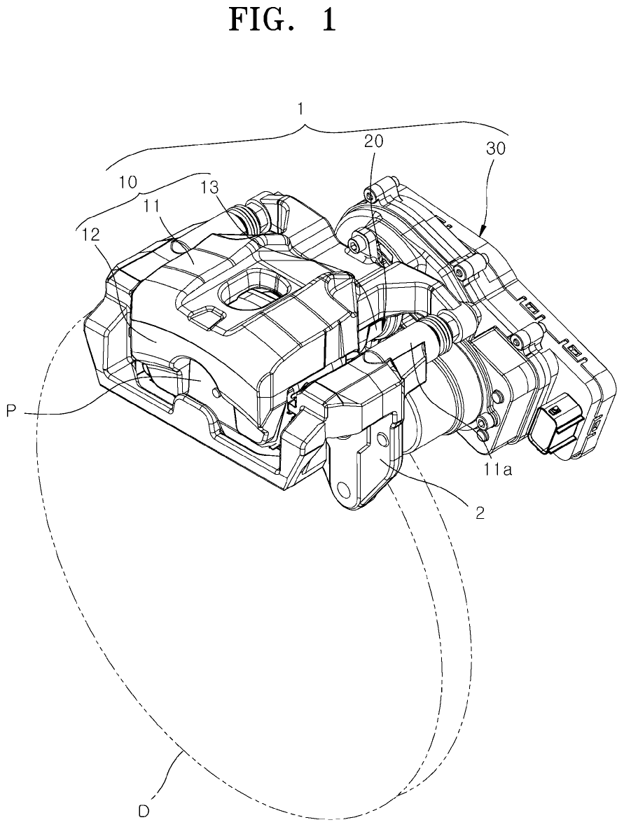

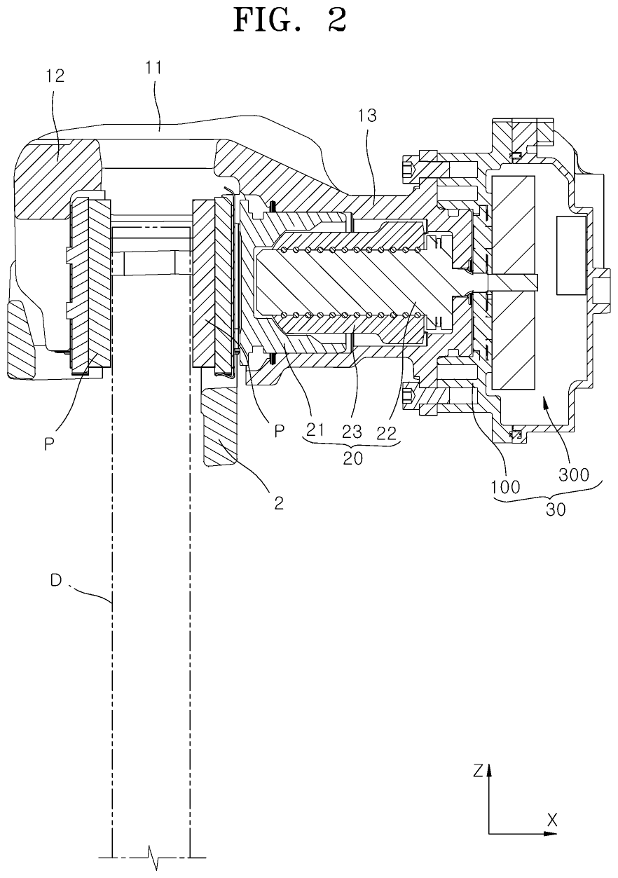

FIG. 1 is a perspective view schematically illustrating a configuration of a brake apparatus according to an embodiment of the present disclosure. FIG. 2 is a cross-sectional view schematically illustrating the configuration of the brake apparatus according to the embodiment of the present disclosure.

Referring to FIGS. 1 and 2, the brake apparatus, which is designated by reference numeral 1, according to the present embodiment includes a caliper body 10, a piston unit 20, and a brake actuator 30.

The caliper body 10 may define a schematic appearance of the brake apparatus and support the piston unit 20 and the brake actuator 30 as a whole.

The caliper body 10 according to this embodiment may include a bridge 11, a finger 12, and cylinder 13.

The bridge 11 may define a central appearance of the caliper body 10 and support the finger 12 and the cylinder 13. The bridge 11 may have a lower surface facing a circumferential surface of a brake disc D with spaced at a predetermined distance therefrom. The bridge 11 may have both sides extending in opposite directions along a direction parallel to the central axis of the brake disc D (X-axis direction in FIG. 1). The bridge 11 is not limited to having the shape illustrated in FIGS. 1 and 2, and may be designed and changed into various shapes.

A pair of brake pads P may be arranged on the lower side of the bridge 11. The pair of brake pads P may be spaced apart from each other along the central axis of the brake disc D. The pair of brake pads P may face each other with the brake disc D interposed therebetween. The pair of brake pads P may be supported on a carrier 2 or the bridge 11 so as to be slidable in a direction parallel to the central axis of the brake disc D. A friction pad, which is made of a material with a high coefficient of friction, such as rubber, may be attached to one surface of each of the brake pads P facing the brake disc D.

The bridge 11 may be movably connected to the carrier 2 fixed to a knuckle (not shown) or the like via a guide rod 11a. The bridge 11 may slide in a direction parallel to the central axis of the brake disc D by the reaction force generated between the piston unit 20 and the associated brake pad P during braking of a vehicle.

The finger 12 may extend downward from one side of the bridge 11. The finger 12 may be integrally connected to the bridge 11 by welding, pressing, bending, or the like. The finger 12 may be disposed to face one of the pair of brake pads P. The finger 12 may press or release one of the pair of brake pads P toward or from the brake disc D by sliding the bridge 11.

The cylinder 13 may extend downward from the other side of the bridge 11. The cylinder 13 may have a hollow cylindrical shape with open at one side. The central axis of the cylinder 13 may be parallel to the central axis of the brake disc D. The open side of the cylinder 13 may be disposed to face the remaining one of the pair of brake pads P.

The piston unit 20 may be movably installed on the caliper body 10. The piston unit 20 may come into contact with or separate from the remaining one of the pair of brake pads (P) depending on the direction of movement thereof. When the piston unit 20 comes into contact with an associated brake pad P, it may press the brake pad P toward the brake disc D so that the brake pad P is in close contact with the brake disc D to apply braking force to the vehicle. The piston unit 20 may release the pressing force applied to the brake pad P when separated from the brake pad P so that the brake pad P is separated from the brake disc D to release the braking force applied to the vehicle.

The piston unit 20 may include a piston 21, a bolt screw 22, and a nut screw 23.

The piston 21 may have a cup shape with open at one side. The closed side of the piston 21 may be directed toward the brake pad P disposed to face the cylinder 13. The open side of the piston 21 may be directed toward the internal space of the cylinder 13. The piston 21 may have an outer surface slidably supported on the inner surface of the cylinder 13. Alternatively, the outer surface of the piston 21 may also be spaced at a predetermined distance from the inner surface of the cylinder 13 to form a gap therebetween.

The piston 21 may move forward and backward in a direction parallel to the central axis of the cylinder 13 (in a direction parallel to the X-axis in FIG. 1). The piston 21 may protrude to the outside of the cylinder 13 when moving forward, and may press the brake pad P, disposed to face the cylinder 13, toward the brake disc D. In this case, the bridge 11 may move in a direction opposite to the direction of movement of the piston 21 by the reaction force generated between the piston 21 and the brake pad P. When the piston 21 moves backward, it may release the pressing force applied to the brake pad P and separate the brake pad P from the brake disc D.

The bolt screw 22 may be disposed inside the cylinder 13 and may be rotated by the driving force received from the brake actuator 30.

As an example, the bolt screw 22 may be in the form of a rod having a substantially circular cross-section. The bolt screw 22 may be disposed inside the cylinder 13, and its central axis may be positioned coaxially with the central axis of the cylinder 13. The bolt screw 22 may have one end facing the inner end surface of the piston 21 with spaced at a predetermined distance therefrom. The bolt screw 22 may have the other end protruding to the outside of the caliper body 10 through the closed side of the cylinder 13. The bolt screw 22 may be rotated clockwise or counterclockwise about the central axis thereof when the brake actuator 30 is operated.

The bolt screw 22 may have a groove, formed on the outer peripheral surface thereof, in which one circumference of a spherical rolling element is seated. The groove may extend spirally in the longitudinal direction of the bolt screw 22 to provide a circulation path for the rolling element.

The nut screw 23 may be disposed inside the cylinder 13 and may be connected to the bolt screw 22. The nut screw 23 may linearly reciprocate in a direction parallel to the longitudinal direction of the bolt screw 22 in conjunction with the rotation of the bolt screw 22 within the cylinder 13. The nut screw 23 may press or release the piston 21 toward or from the brake pad P depending on the direction of movement thereof.

As an example, the nut screw 23 may have a hollow cylindrical shape. The nut screw 23 may have an inner peripheral surface facing the outer peripheral surface of the bolt screw 22 with spaced at a predetermined distance therefrom. The nut screw 23 may have a groove, formed on the inner peripheral surface thereof, in which the other circumference of the spherical rolling element is seated. The groove may extend spirally in the longitudinal direction of the nut screw 23 to provide a circulation path for the rolling element.

The nut screw 23 may receive the rotational force of the bolt screw 22 via the rolling element. When the bolt screw 22 is rotated, the nut screw 23 may move forward and backward in the longitudinal direction of the bolt screw 22 by circulation movement of the rolling element.

When the nut screw 23 moves forward, it may come into contact with the inner surface of the piston 21 to press the piston 21 toward the brake disc D. When the nut screw 23 moves backward, it may be is separated from the inner surface of the piston 21 to release the pressing force applied to the piston 21.

The brake actuator 30 may be connected to the piston unit 20 and may move the piston unit 20. In other words, the brake actuator 30 may function as a component that generates driving force for applying or releasing braking force to or from the vehicle and transmits the generated driving force to the piston unit 20.

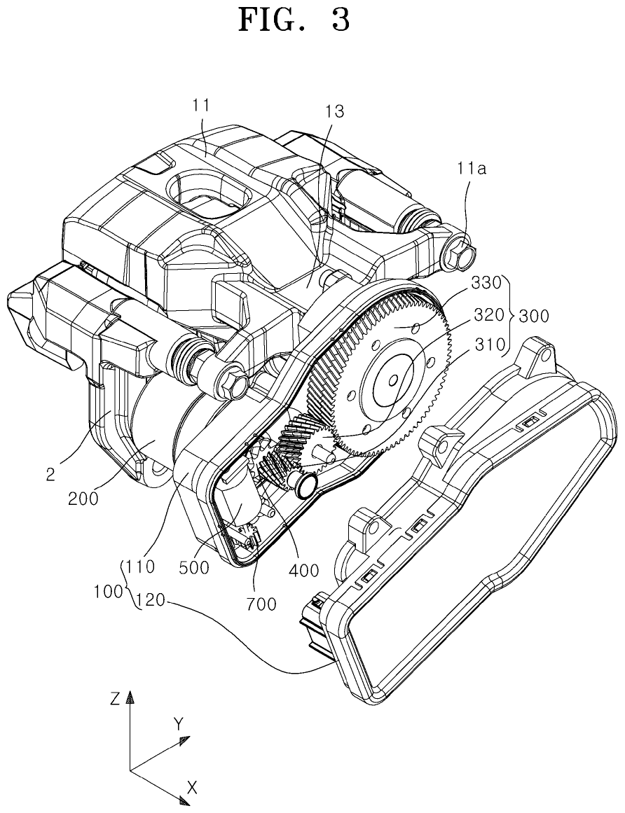

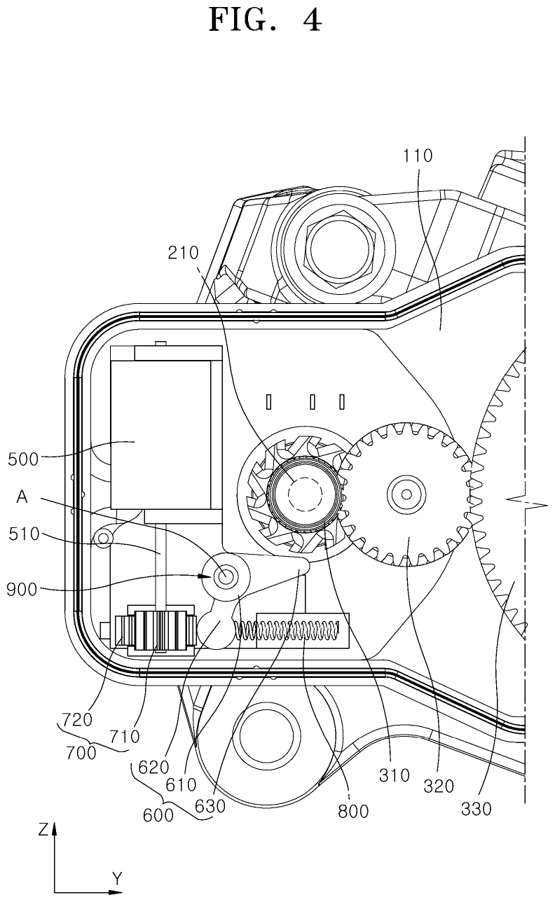

FIG. 3 is a perspective view schematically illustrating the configuration of the brake actuator according to the embodiment of the present disclosure. FIG. 4 is a front view schematically illustrating the configuration of the brake actuator according to the embodiment of the present disclosure.

Referring to FIGS. 3 and 4, the brake actuator 30 according to this embodiment includes a casing 100, a first motor 200, a transmission gear 300, a first parking member 400, a second motor 500, and a second parking member 600.

The casing 100 may be fixed to the caliper body 10, and may support the first motor 200, the transmission gear 300, the first parking member 400, the second motor 500, and the second parking member 600 as a whole.

The casing 100 may include a casing body 110 and a casing cover 120.

The casing body 110 may have a hollow cylindrical shape with open at one side. The closed side of the casing body 110 may be disposed to face the rear of the cylinder 13. The casing body 110 may be fixed to the rear of the cylinder 13 by various types of coupling methods such as bolting, welding, and fitting. The casing body 110 is not limited to having the shape illustrated in FIGS. 3 and 4, and may be designed and changed into various shapes.

The casing cover 120 may be disposed to face the casing body 110 and may close the internal space of the casing body 110. The casing cover 120 may have a substantially plate shape and may be disposed to face the open side of the casing body 110. The casing cover 120 may be fixed to the open side of the casing body 110 by various types of coupling methods such as bolting, welding, and fitting. The cross-sectional shape of the casing cover 120 may correspond to the cross-sectional shape of the casing body 110.

The first motor 200 is installed in the casing 100 and generates rotational force to move the piston unit 20. As an example, the first motor 200 may be exemplified as various types of electric motors that may rotate a first output shaft 210 by receiving power from the outside. The first motor 200 may be fixed to the outside of the casing body 110 by various types of coupling methods such as bolting, welding, and fitting. The first output shaft 210 may protrude through the casing body 110 to the internal space thereof. The first output shaft 210 may be disposed such that the longitudinal direction thereof is parallel to the longitudinal direction of the bolt screw 22 in the cylinder 13, e.g., the X-axis direction in FIG. 3. The first motor 200 may be electrically connected to the battery or the like of the vehicle for receiving power therefrom.

The transmission gear 300 may be rotatably installed in the casing 100. The transmission gear 300 is connected to the first motor 200 and rotated in conjunction with the rotational force generated by the first motor 200. The transmission gear 300 may function as a component that transmits the rotational force generated by the first motor 200 to the piston unit 20.

The transmission gear 300 may include a first transmission gear 310, a second transmission gear 320, and a third transmission gear 330.

The first transmission gear 310 may be connected to the first output shaft 210 of the first motor 200. As an example, the first transmission gear 310 may be a hollow helical gear or spur gear with teeth formed on the outer peripheral surface thereof. The central axis of the first transmission gear 310 may be disposed coaxially with the central axis of the first output shaft 210 of the first motor 200. The first transmission gear 310 may have an inner peripheral surface splined to the outer peripheral surface of the first output shaft 210. Accordingly, the first transmission gear 310 may be rotated at the same angular speed as the first output shaft 210 when the first motor 200 is operated.

The second transmission gear 320 may be engaged with the first transmission gear 310 and may be rotated in conjunction with the rotation of the first transmission gear 310. As an example, the second transmission gear 320 may be a hollow helical gear or spur gear with teeth formed on the outer peripheral surface thereof. The central axis of the second transmission gear 320 may be disposed parallel to the central axis of the first transmission gear 310. The second transmission gear 320 may be supported so as to be rotatable about its central axis within the casing 100 by a separate shaft (not shown) or the like. The second transmission gear 320 may have an outer peripheral surface engaged with the outer peripheral surface of the first transmission gear 310. The second transmission gear 320 may be rotated in a direction opposite to the first transmission gear 310 when the first transmission gear 310 is rotated. The second transmission gear 320 may have a larger diameter than the first transmission gear 310. Accordingly, the second transmission gear 320 may amplify the magnitude of the rotational force transmitted from the first transmission gear 310.

The third transmission gear 330 may be engaged with the second transmission gear 320 and may be rotated in conjunction with the rotation of the second transmission gear 320. The third transmission gear 330 may function as a component that finally transmits the rotational force generated by the first motor 200 to the piston unit 20. As an example, the third transmission gear 330 may be a hollow helical gear or spur gear with teeth formed on the outer peripheral surface thereof. The central axis of the third transmission gear 330 may be disposed parallel to the central axis of the second transmission gear 320. The central axis of the third transmission gear 330 may be positioned coaxially with the central axis of the bolt screw 22 of the piston unit 20. The third transmission gear 330 may have an outer peripheral surface engaged with the outer peripheral surface of the second transmission gear 320. The third transmission gear 330 may be rotated about its central axis in a direction opposite to the second transmission gear 320 when the second transmission gear 320 is rotated. The rear end of the bolt screw 22 protruding from the rear of the cylinder 13 may be inserted into the center of the third transmission gear 330. The bolt screw 22 may have an outer peripheral surface splined to the inner peripheral surface of the third transmission gear 330. Accordingly, when the third transmission gear 330 is rotated, the bolt screw 22 may rotate together with the third transmission gear 330 to move the nut screw 23 forward and backward. The third transmission gear 330 may have a larger diameter than the second transmission gear 320. Accordingly, the third transmission gear 330 may be rotated at a lower angular speed than the second transmission gear 320 when the second transmission gear 320 is rotated, and may amplify the magnitude of the rotational force transmitted to the piston unit 20.

When the first output shaft 210 is rotated in a direction of braking application, the rotational force of the first output shaft 210 may be sequentially transmitted to the first transmission gear 310, the second transmission gear 320, the third transmission gear 330, and the bolt screw 220, and the nut screw 23 and the piston 21 may move forward to bring the brake pad P into close contact with the brake disc D.

When the first output shaft 210 is rotated in a direction of braking release, the rotational force of the first output shaft 210 may be sequentially transmitted to the first transmission gear 310, the second transmission gear 320, the third transmission gear 330, and the bolt screw 220, and the nut screw 23 and the piston 21 may move backward to separate the brake pad P from the brake disc D.

The first parking member 400 may function as a component that rotates together with the transmission gear 300 and maintains parking braking force together with the second parking member 600.

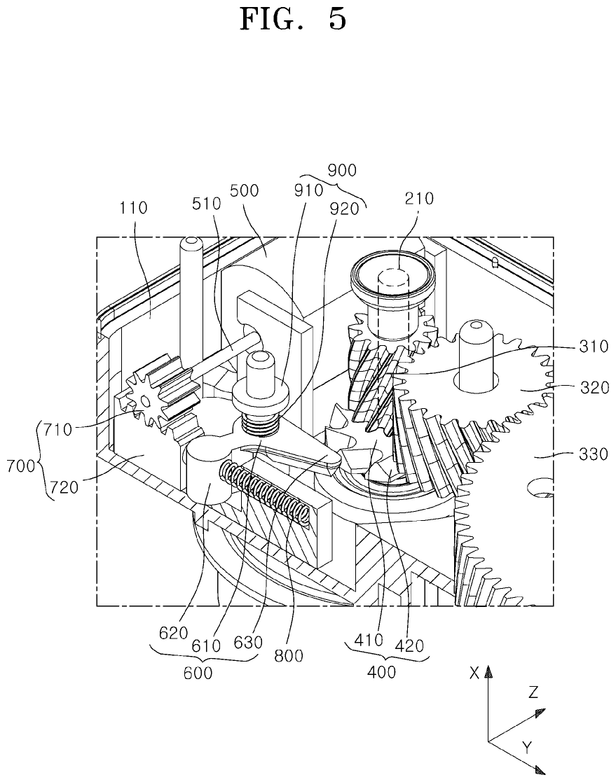

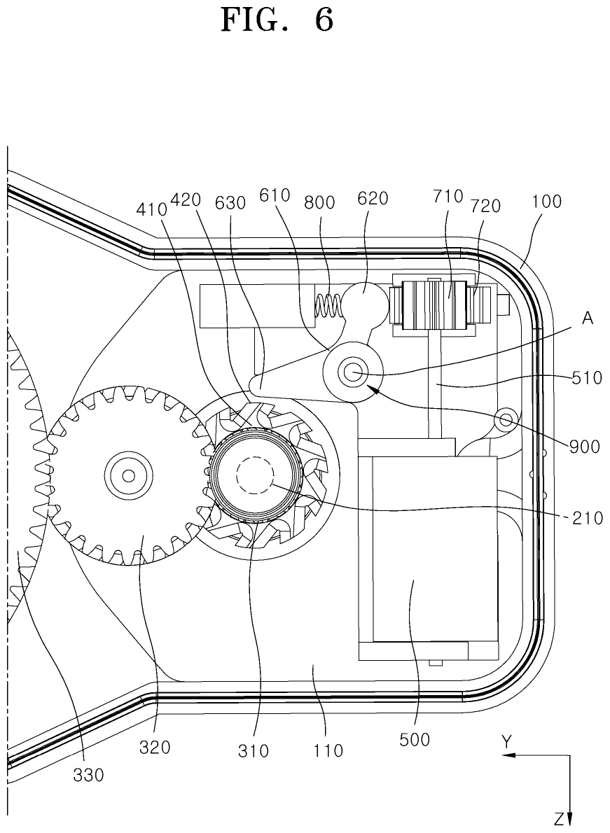

FIG. 5 is a perspective view schematically illustrating the configuration of the first parking member, the second parking member, and a conversion member according to the embodiment of the present disclosure. FIG. 6 is a front view schematically illustrating the configuration of the first parking member, the second parking member, and the conversion member according to the embodiment of the present disclosure.

Referring to FIGS. 1 to 6, the first parking member 400 may include a first parking body 410 and an extension part 420.

The first parking body 410 may be connected to the first output shaft 210 of the first motor 200. As an example, the first parking body 410 may be in the form of a ring with a hollow formed in the center thereof. The central axis of the first parking body 410 may be positioned coaxially with the central axis of the first output shaft 210. The first parking body 410 may have an inner peripheral surface splined to the outer peripheral surface of the first output shaft 210. When the first output shaft 210 is rotated, the first parking body 410 may be rotated at the same angular speed as the first output shaft 210 and the first transmission gear 310. Accordingly, the first parking body 410 may decrease the size of the load applied to the second parking member 600, compared to when it is connected to the second transmission gear 320 or the third transmission gear 330 whose rotational force is multiplied by the gear ratio thereof. When the first output shaft 210 is rotated, the first parking body 410 may be rotated in a direction of braking application or in a direction of braking release together with the first output shaft 210.

The extension part 420 may function as a component that extends from the first parking body 410 and forms an interference structure with the second parking member 600. As an example, the extension part 420 may protrude from the circumferential surface of the first parking body 410 to the outside of the first parking body 410. The extension part 420 may consist of a plurality of extension parts. The plurality of extension parts 420 may be arranged at set intervals along the circumferential surface of the first parking body 410 around the central axis of the first parking body 410. The distance between neighboring extension parts 420 may all be the same.

Each extension part 420 may extend obliquely in relation to the radial direction of the first parking body 410. As an example, the extension part 420 may be inclined at a set angle or may extend spirally in a curved shape in a direction of braking release, namely, in a counterclockwise direction in FIG. 6 from the circumferential surface of the first parking body 410. Accordingly, when the extension part 420 is fastened to the second parking member 600, it may permit the first parking body 410 to rotate in the direction of braking release, and at the same time, may limit rotation of the first parking body 410 in the direction of braking release.

The second motor 500 is installed in the casing 100 and generates rotational force to rotate the second parking member 600. As an example, the second motor 500 may be exemplified as various types of electric motors that may rotate a second output shaft 510 by receiving power from the outside. The second motor 500 may be spaced apart from the first motor 200. The second motor 500 may be disposed inside the casing body 110, or alternatively, may be disposed outside the casing body 110. The second motor 500 may be fixed to the casing body 110 by various types of coupling methods such as bolting, welding, and fitting. The second motor 500 may be electrically connected to the battery or the like of the vehicle for receiving power therefrom.

The second output shaft 510 may be disposed in the internal space of the casing body 110. The second output shaft 510 may be disposed such that the longitudinal direction thereof is misaligned with the longitudinal direction of the first output shaft 210. The misalignment of the first output shaft 210 and the second output shaft 510 may mean that they intersect each other on the same plane or are twisted together in three-dimensional space. As an example, in FIG. 6, the second output shaft 510 may be disposed such that the longitudinal direction thereof is parallel to the Z-axis direction, and the first output shaft 210 may be disposed such that the longitudinal direction thereof is parallel to the X-axis direction.

The second parking member 600 may be rotatably installed in the casing 100. The second parking member 600 may be rotated by the operation of the second motor 500 and the conversion member 700 and may selectively limit the rotation of the first parking member 400 depending on the direction of rotation thereof. More specifically, the second parking member 600 may permit the first parking member 400 to rotate during normal driving of the vehicle, thereby smoothly performing main braking by the first motor 200. In addition, the second parking member 600 may limit the rotation of the first parking member 400 during main braking of the vehicle, thereby preventing the piston unit 20 from losing parking braking force by arbitrary separation from the brake pad P even if the operation of the first motor 200 is stopped.

The second parking member 600 may include a second parking body 610, a lever 620, and a latching part 630.

The second parking body 610 may define a central appearance of the second parking member 600 and may support the lever 620 and the latching part 630 as a whole. The second parking body 610 may be installed so as to be rotatable about a rotary shaft A parallel to the first output shaft 210. As an example, the second parking body 610 may have a cylindrical shape, and may be rotatably supported on the rotary shaft A extending parallel to the first output shaft 210 from the casing body 110.

The second parking body 610 may be rotated about the rotary shaft A in a first direction of rotation and a second direction of rotation opposite to the first direction of rotation. The rotation of the second parking body 610 in the first direction of rotation may mean that the second parking body 610 is rotated counterclockwise about the rotary shaft A in FIG. 6, and the rotation of the second parking body 610 in the second direction of rotation may mean that the second parking body 610 is rotated clockwise about the rotary shaft A in FIG. 6.

The lever 620 may extend from one side of the second parking body 610. The lever 620 may function as a component that transmits the driving force applied from the conversion member 700 to the second parking body 610. More specifically, the lever 620 may convert the linear motion of the conversion member 700 into the rotational motion of the second parking body 610 around the rotary shaft A. As an example, the lever 620 may be in the form of a rod extending in the radial direction of the second parking body 610 from the circumferential surface of the second parking body 610.

The latching part 630 may extend from the other side of the second parking body 610 and may be spaced apart from the lever 620. The latching part 630 may limit or permit the rotation of the extension part 420 depending on the direction of rotation of the second parking body 610.

As an example, the latching part 630 may extend in the radial direction of the second parking body 610 from the circumferential surface of the second parking body 610. The longitudinal direction of the latching part 630 may be inclined at a set angle about the rotary shaft A in relation to the longitudinal direction of the lever 620. In other words, the lever 620 and the latching part 630 may extend in different directions from the circumferential surface of the second parking body 610.

The latching part 630 may have an end directed toward the first parking member 400. The latching part 630 may be inserted between any associated pair of neighboring extension parts 420 as the second parking body 610 is rotated in the first direction of rotation. In this case, the latching part 630 may be latched to the associated extension part 420 to limit the rotation of the first parking body 410. The latching part 630 may be separated from the associated pair of neighboring extension parts 420 as the second parking body 610 is rotated in the second direction of rotation. In this case, the latching part 630 may be unlatched from the associated extension part 420 to permit the rotation of the first parking body 410.

The latching part 630 may gradually narrow in width toward the end thereof. Accordingly, the latching part 630 may be more easily inserted between any associated pair of neighboring extension parts 420 when the second parking body 610 is rotated in the first direction of rotation.

The conversion member 700 may convert the rotational force of the second motor 500 into linear motion to rotate the second parking member 600. The conversion member 700 may be provided between the second motor 500 and the second parking member 600. As the second parking member 600 is indirectly connected to the second motor 500 via the conversion member 700, the second output shaft 510 may be misaligned with the first output shaft 210, thereby increasing the degree of freedom in placement of the second motor 500.

The conversion member 700 may include a first conversion gear 710 and a second conversion gear 720.

The first conversion gear 710 may be connected to and rotated together with the second output shaft 510. As an example, the first conversion gear 710 may be a pinion gear with gear teeth formed on the outer peripheral surface thereof. The central axis of the first conversion gear 710 may be positioned coaxially with the central axis of the second output shaft 510. The first conversion gear 710 may have an inner peripheral surface splined to the outer peripheral surface of the second output shaft 510. Accordingly, the first conversion gear 710 may be rotated at the same angular speed as the second output shaft 510 when the second output shaft 510 is rotated.

The second conversion gear 720 may be connected to the first conversion gear 710. The second conversion gear 720 may linearly reciprocate in a first direction and a second direction opposite to the first direction in conjunction with the rotation of the first conversion gear 710. The second conversion gear 720 may press or release the lever 620 depending on the direction of movement thereof and may rotate the second parking body 610.

As an example, the second conversion gear 720 may be a rack gear with gear teeth formed on one surface thereof. One surface of the second conversion gear 720 may be engaged to the outer peripheral surface of the first conversion gear 710. The second conversion gear 720 may have an end facing one surface of the lever 620. The second conversion gear 720 may reciprocate linearly and longitudinally in the first direction and the second direction when the first conversion gear 710 is rotated. The first direction may refer to, for example, a direction that is parallel to the longitudinal direction of the second conversion gear 720 and in which the end of the second conversion gear 720 is moved linearly toward one surface of the lever 620. The second direction may refer to, for example, a direction that is parallel to the longitudinal direction of the second conversion gear 720 and in which the end of the second conversion gear 720 is moved linearly away from one surface of the lever 620. As an example, the first direction may refer to a left direction and the second direction may refer to a right direction in FIG. 6.

The second conversion gear 720 may press the lever 620 in the first direction as it moves in the first direction. When the second conversion gear 720 presses the lever 620 in the first direction, the second parking body 610 may be rotated about the rotary shaft A in a first direction of rotation (in a counterclockwise direction in FIG. 6).

As the second conversion gear 720 moves in the second direction, it may release the pressing force applied to the lever 620 in the first direction. When the second conversion gear 720 releases the lever 620, the second parking body 610 may be rotated about the rotary shaft A in a second direction of rotation (in a clockwise direction in FIG. 6) by the rotational force of the first parking member 400 or by a separate pressing means (e.g., a return member 800 to be described later).

The brake actuator 30 may further include a return member 800. The return member 800 may be connected to the lever 620 to press the lever 620 in the second direction. The return member 800 may be configured to be elastically deformable in a direction parallel to the first and second directions. The return member 800 may function as a component that, when the second conversion gear 720 releases the pressing force applied to the lever 620, returns the lever 620 to its initial position by its own elastic restoring force. Accordingly, the return member 800 may return the lever 610 to its initial position without driving the second motor 500, thereby implementing the bidirectional rotation of the second parking body 610 only by ON/OFF control of the second motor 500.

As an example, the return member 800 may be a compression spring that is elastically deformable in the longitudinal direction thereof. The return member 800 may be disposed such that the longitudinal direction thereof is parallel to the longitudinal direction of the second conversion gear 720. The return member 800 may be disposed to face the other surface of the lever 620. In other words, the return member 800 may be disposed to face the second conversion gear 720 with the lever 620 interposed therebetween. One end of the return member 800 may be in contact with the other surface of the lever 620. One end of the return member 800 may be simply in contact with the other surface of the lever 620, or otherwise may be fixed to the other surface of the lever 620. The other end of the return member 800 may be fixed to the casing body 110 or a separate support means (not shown) installed in the casing body 110.

When the second parking body 610 and the lever 620 are rotated about the rotary shaft A in the first direction of rotation, the return member 800 may be elastically deformed in the longitudinal direction thereof, thereby accumulating elastic energy to press the lever 620 in the second direction. When the second conversion gear 720 moves in the second direction to release the lever 620, return member 800 may press the lever 620 in the second direction by the accumulated elastic energy and rotate the second parking body 610 in the second direction of rotation.

Meanwhile, when the return member 800 is not installed, the end of the second conversion gear 720 may be directly fixed to one surface of the lever 620. In this case, as the second conversion gear 720 moves in the second direction, it may pull the lever 620 in the second direction and rotate the second parking body 610 in the second direction of rotation.

The second parking body 610 may be installed to be reciprocate in the longitudinal direction of the rotary shaft A. As an example, the second parking body 610 may have an inner peripheral surface splined to the outer peripheral surface of the rotary shaft A.

The side surface of the latching part 630 may be inclined in relation to the longitudinal direction of the rotary shaft A. As an example, the latching part 630 may gradually narrow in cross-sectional area as it is directed downward in FIG. 5.

The side surface of the extension part 420 may also be inclined in relation to the longitudinal direction of the first output shaft 210. In this case, the side surface of the extension part 420 may be formed at an angle corresponding to the side inclination of the latching part 630 so as to be in surface contact with the side surface of the latching part 630. As an example, the extension part 420 may gradually narrow in cross-sectional area as it is directed upward in FIG. 5. Alternatively, the side surface of the extension part 420 may be parallel to the longitudinal direction of the first output shaft 210.

A portion of the reaction force acting between the extension part 420 and the latching part 630 may be transmitted in a direction parallel to the longitudinal direction of the rotary shaft A by the angles of inclination of the side surfaces of the extension part 420 and the latching part 630. In this case, when the reaction force acting between the extension part 420 and the latching part 630 increases beyond a set magnitude, the second parking body 610 may be moved linearly in a direction of departure parallel to the longitudinal direction of the rotary shaft A. When the second parking body 610 is moved in the direction of departure, the latching part 630 may be separated from the extension part 420. As an example, the direction of departure may refer to an upward direction in FIG. 5. Accordingly, if the second parking body 610 is not rotated smoothly in the second direction of rotation due to pinching between the extension part 420 and the latching part 630 or damage to the return member 800, the latching part 630 may be unlatched from the extension part 420 by forced rotation of the first output shaft 210.

The brake actuator 30 may further include a restoration member 900.

After the second parking body 610 is moved in the direction of departure, the restoration member 900 may move the second parking body 610 in a direction opposite to the direction of departure. Accordingly, the restoration member 900 may returns the second parking body 610 to its initial position after the extension part 420 and the latching part 630 are forcibly separated, thereby preventing the permanent loss of the main braking maintenance performance of the brake actuator 30.

The restoration member 900 may include a restoration body 910 and an elastic member 920.

The restoration body 910 may be spaced apart from the second parking body 610 in a direction parallel to the longitudinal direction of the rotary shaft A. As an example, the restoration body 910 may be in the form of a disk extending in the radial direction of the rotary shaft A from the circumferential surface of the rotary shaft A. The lower surface of the restoration body 910 may face the upper surface of the second parking body 610. Alternatively, the upper surface of the restoration body 910 may face the lower surface of the second parking body 610.

The elastic member 920 may be configured to be elastically deformable in a direction parallel to the longitudinal direction of the rotary shaft A. As an example, the elastic member 920 may be a compression spring that is elastically deformable in the longitudinal direction thereof. The elastic member 920 may be disposed such that the longitudinal direction thereof is parallel to the longitudinal direction of the rotary shaft A. The central axis of the elastic member 920 may be positioned coaxially with the central axis of the rotary shaft A. The elastic member 920 may have both ends that are in contact with respective facing surfaces of the restoration body 910 and the second parking body 610.

When the second parking body 610 is located at its initial position, the elastic member 920 may be installed in an untensioned or uncompressed neutral state. When the second parking body 610 is moved in the direction of departure, the elastic member 920 may be tensioned or compressed longitudinally to accumulate elastic energy. After the extension part 420 and the latching part 630 are forcibly separated, the elastic member 920 may press or pull the second parking body 610 in a direction opposite to the direction of departure by the accumulated elastic energy to return the second parking body 610 to its initial position. The initial position of the second parking body 610 may be designed and changed in various ways within the range of the position where the latching part 630 is insertable between the associated pair of neighboring extension parts 420 when the second parking body 610 is rotated in the first direction of rotation.

Although it has been described above as an example that the second parking body 610 is installed to reciprocate in the longitudinal direction of the rotary shaft A, the present disclosure is not limited thereto. For example, the first parking body 410 may also be installed to reciprocate in the longitudinal direction of the first output shaft 210. In this case, the restoration member 900 may be positioned and have a structure to press the first parking body 410 in a direction opposite to the direction of departure.

The brake actuator 30 may further include a control module.

The control module is connected to the first motor 200 and the second motor 500, and controls the operation of the first motor 200 and the second motor 500. More specifically, the control module may control the operation of the first motor 200 and the second motor 500 based on the braking signal or brake release signal generated by a driver's brake pedal operation or a parking braking command. The control module may be implemented as an integrated circuit (IC), a microcontroller (μC), a microprocessor, an application specific integrated circuit (ASIC), or a combination thereof, which may be electrically connected to the first motor 200 and the second motor 500 and may control whether the first output shaft 210 and the second output shaft 510 rotate, the rotation speeds of the first output shaft 210 and second output shaft 510, and the like. The control module may control the directions of rotation of the first output shaft 210 and the second output shaft 510 only in one direction through ON/OFF operation. Alternatively, the control module may bidirectionally control the directions of rotation of the first output shaft 210 and the second output shaft 510 through multiple circuits. The control module may be disposed inside the casing 100, or otherwise may be coupled to the outer surface of the casing 100.

Hereinafter, the operation of the brake actuator 30 according to the embodiment of the present disclosure will be described.

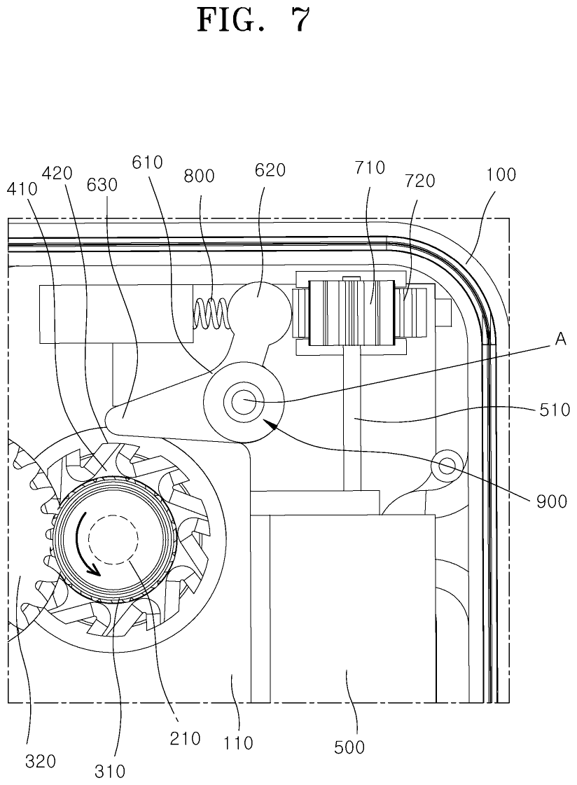

FIGS. 7 to 9 are views schematically illustrating a process of generating parking braking force.

Referring to FIGS. 7 to 9, during parking braking, in a state in which the second parking body 610 is located at its initial position, the first motor 200 may rotate the first output shaft 210 in a direction of braking application (in a counterclockwise direction in FIG. 7).

As the first output shaft 210 is rotated in the direction of braking application, the rotational force of the first output shaft 210 may be transmitted to the piston unit 20 through the transmission gear 300 and the brake pad P may come into contact with the brake disc D to generate braking force in the vehicle.

In this case, the first parking member 400 may be rotated in the direction of braking application together with the first output shaft 210.

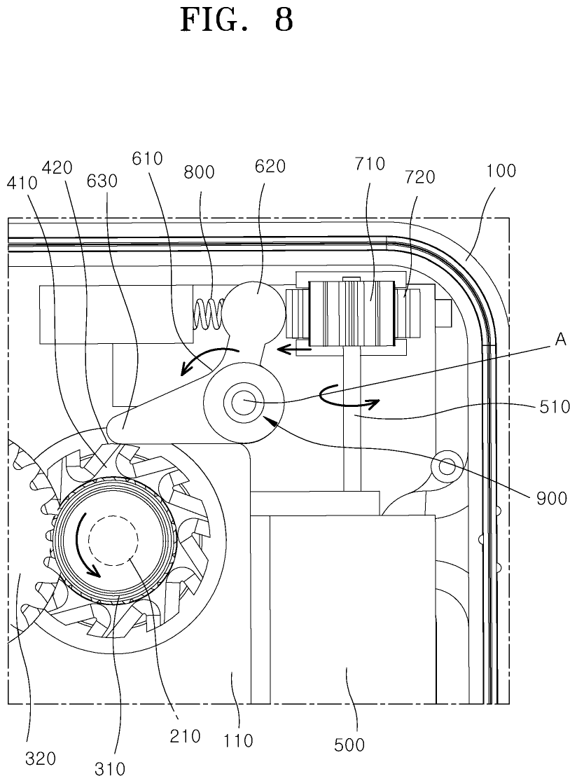

The second motor 500 then rotates the second output shaft 510 to move the second conversion gear 720 in the first direction (to the left in FIG. 8).

The second conversion gear 720 may press the lever 620 in the first direction as it moves in the first direction.

When the second conversion gear 720 presses the lever 620 in the first direction, the pressing force applied to the lever 620 in the first direction may be converted into a rotational force in the first direction of rotation (in the counterclockwise direction in FIG. 8) around the rotary shaft A, and the second parking body 610 may be rotated about the rotary shaft A in the first direction of rotation.

When the second parking body 610 and the lever 620 are rotated about the rotary shaft A in the first direction of rotation, the return member 800 may be elastically deformed in the longitudinal direction thereof, thereby accumulating elastic energy to press the lever 620 in the second direction.

As the second parking body 610 is rotated at more than a set angle in the first direction of rotation, the latching part 630 may be inserted between any associated pair of neighboring extension parts 420.

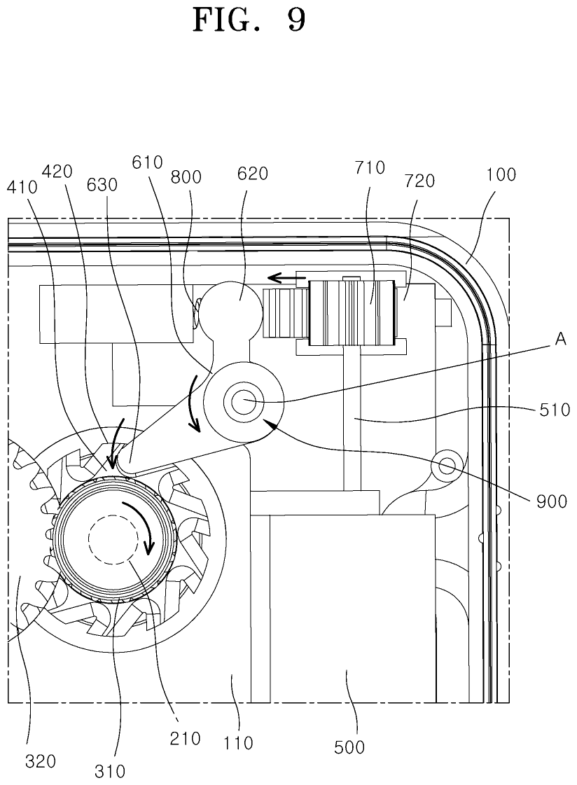

Then, the operation of the first motor 200 is stopped, and a rotational force is generated in the first output shaft 210 in a direction of braking release (in a clockwise direction in FIG. 9) by the reaction force acting between the brake disc D and the brake pad P.

The extension part 420 and the latching part 630 are unlatched from each other by the rotational force applied to the first output shaft 210 in the direction of braking release.

The rotational force applied to the first output shaft 210 in the direction of braking release may be offset by the latching force between the extension part 420 and the latching part 630 and the supporting force of the second stopper 662 with respect to the first stopper 661, and the parking braking may be maintained by limiting the rotation of the first parking body 410 and the first output shaft 210.

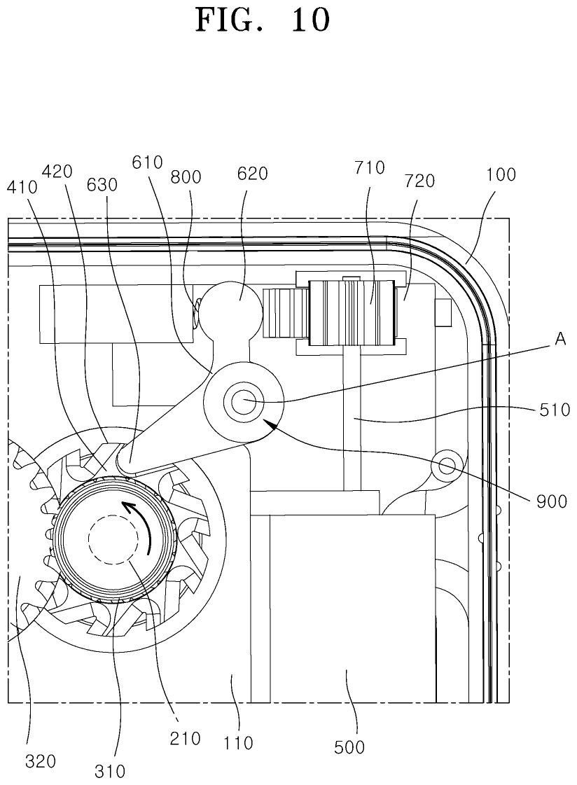

FIGS. 10 to 12 are views schematically illustrating a process of releasing parking braking force.

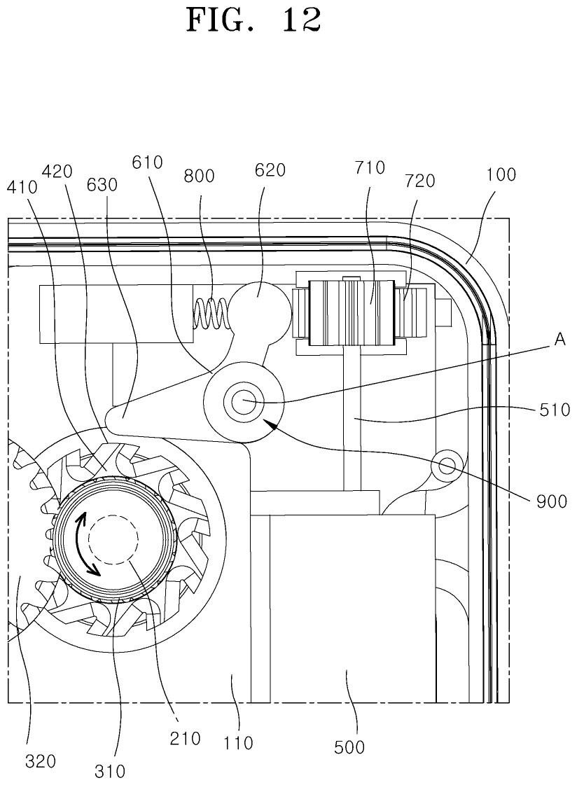

Referring to FIGS. 1 to 12, when the parking braking is released, in the state of FIG. 9, the first motor 200 may rotate the first output shaft 210 at a certain angle in a direction of braking application (in a counterclockwise direction in FIG. 12).

As the first output shaft 210 is rotated in the direction of braking application, the magnitude of the reaction force acting between the extension part 420 and the latching part 630 is decreased.

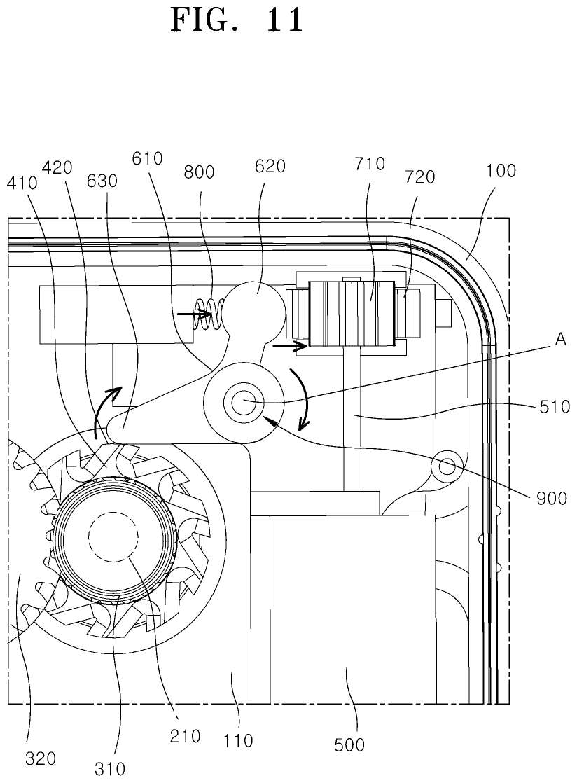

Due to this reduction in reaction force, the second parking body 610 is rotated about the rotary shaft A in a second direction of rotation (in a clockwise direction in FIG. 11) by the pressing force of the return member 800 to the lever 620 in the second direction.

As the second parking body 610 and the lever 620 is rotated about the rotary shaft A in the direction of rotation, the second conversion gear 720 may be moved linearly in the second direction without driving the second motor 500, and the lever 620 may be returned to its initial position.

As the second parking body 610 is rotated in the direction of rotation, the latching part 630 is separated from the pair of neighboring extension parts 420 and the rotation of the first parking body 410 and the first output shaft 210 is permitted.

Then, the first output shaft 210 may be rotated in the direction of braking release (in the clockwise direction in FIG. 12), thereby releasing the parking braking force.

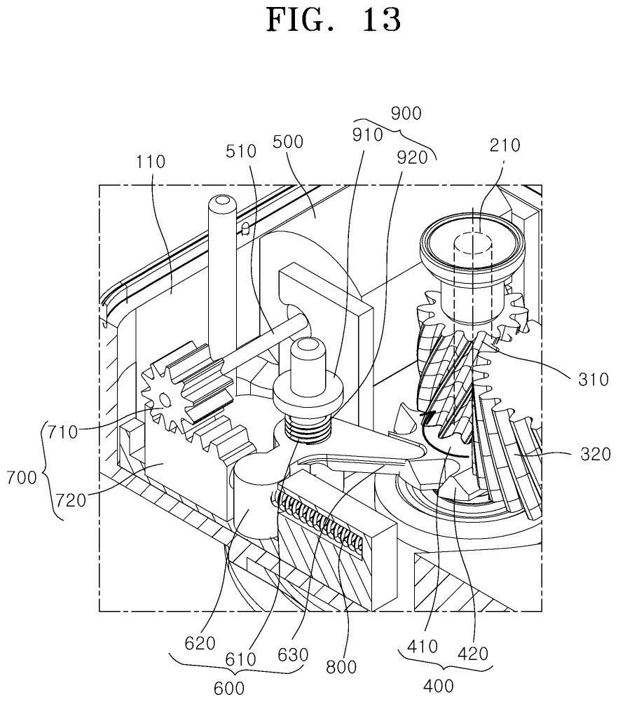

FIGS. 13 to 15 are views schematically illustrating a process of forcibly releasing parking braking force.

Referring to FIGS. 1 to 15, if the first output shaft 210 is not rotated in the direction of braking application (in the counterclockwise direction in FIG. 13) and the second parking body 610 is not rotated about the rotary shaft A in the second direction of rotation (in the clockwise direction in FIG. 13) due to pinching between the extension part 420 and the latching part 630 or damage to the return member 800, the first motor 200 forcibly rotates the first output shaft 210 in the direction of braking release (in the clockwise direction in FIG. 13).

As the first output shaft 210 is rotated in the direction of braking release, the magnitude of the reaction force acting between the extension part 420 and the latching part 630 is increased.

A portion of the reaction force acting between the extension part 420 and the latching part 630 is transmitted in a direction parallel to the longitudinal direction of the rotary shaft A by the angles of inclination of the side surfaces of the extension part 420 and the latching part 630.

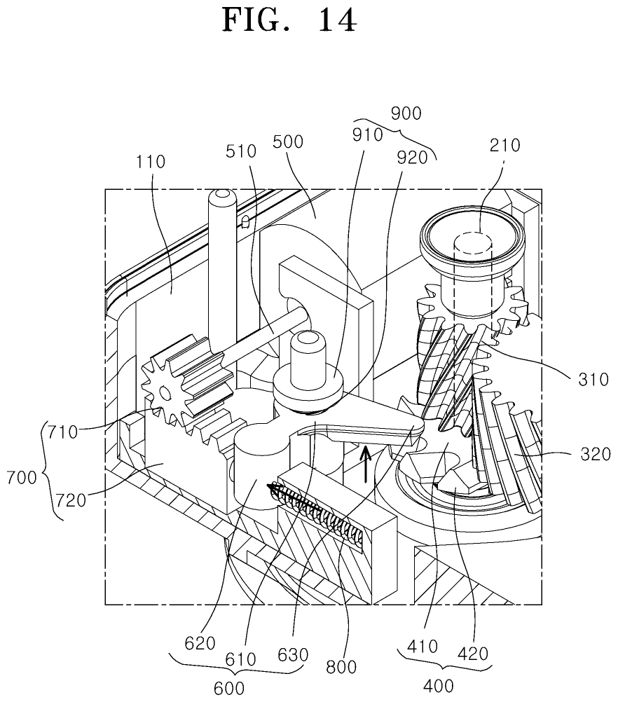

When the reaction force acting between the extension part 420 and the latching part 630 increases beyond a set magnitude, the second parking body 610 is moved linearly in a direction of departure (in an upward direction in FIG. 14) parallel to the longitudinal direction of the rotary shaft A.

The extension part 420 may be moved relative to the latching part 630 in the longitudinal direction of the rotary shaft A, and the extension part 420 and the latching part 630 may be separated from each other.

In this process, the elastic member 920 is elastically deformed in the longitudinal direction of the rotary shaft A to accumulate elastic energy to restore the second parking body 610 to its initial position.

As the extension part 420 and the latching part 630 are separated from each other, the first output shaft 210 may be rotated in the direction of braking release.

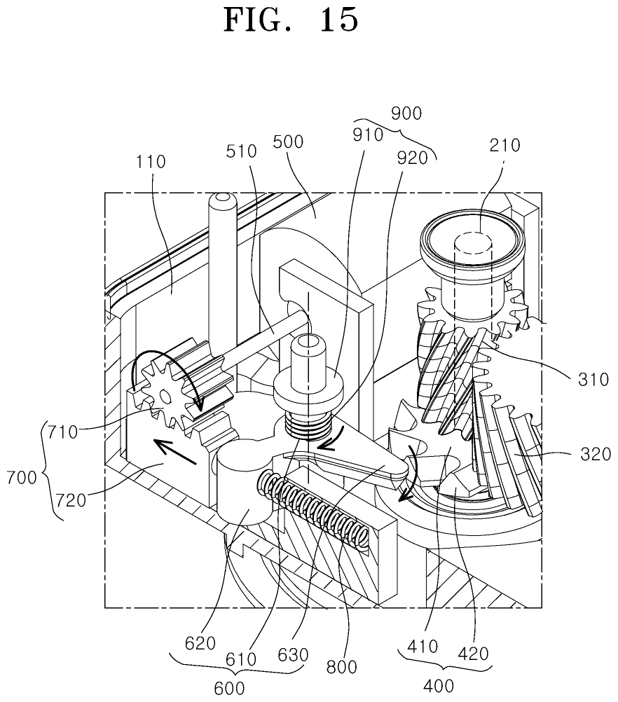

Then, when the second parking body 610 is returned to its initial position by the elastic restoring force of the return member 800, the driving force of the second motor 500, or manually, the first parking body 610 may be moved in a direction opposite to the direction of departure (in a downward direction in FIG. 15) and may be returned to its initial position.

While the present disclosure has been described with respect to the embodiments illustrated in the drawings, it will be obvious to those skilled in the art that such embodiments are provided by way of example only. It will be understood by those skilled in the art that various modifications and other equivalent embodiments may be made without departing from the spirit and scope of the disclosure as defined in the following claims.

Therefore, the technical protection scope of the present disclosure should be defined by the following claims.

What is claimed is:

1. A brake actuator comprising:
a casing;
a first motor installed in the casing;
a transmission gear rotatably installed in the casing and connected to the first motor;
a first parking member configured to rotate together with the transmission gear;
a second motor spaced apart from the first motor;
a second parking member rotatably installed in the casing and configured to selectively limit rotation of the first parking member depending on a direction of rotation of the first parking member; and
a conversion member configured to convert rotational force of the second motor into a linear motion to rotate the second parking member.

2. The brake actuator according to claim 1, wherein the first parking member comprises:
a first parking body connected to a first output shaft of the first motor; and
a plurality of extension parts extending from the first parking body and arranged along a circumferential surface of the first parking body.

3. The brake actuator according to claim 2, wherein each of the extension parts extends obliquely in relation to a radial direction of the first parking body.

4. The brake actuator according to claim 2, wherein the second parking member comprises:
a second parking body installed to be rotatable about a rotary shaft parallel to the first output shaft;
a lever extending from one side of the second parking body and configured to convert the linear motion of the conversion member into a rotational motion of the second parking body; and
a latching part extending from another side of the second parking body and selectively inserted between a pair of neighboring extension parts as the second parking body rotates in a first direction of rotation.

5. The brake actuator according to claim 4, wherein the conversion member comprises:
a first conversion gear connected to and rotating together with a second output shaft of the second motor; and
a second conversion gear connected to the first conversion gear, installed to be linearly movable in a first direction or a second direction opposite to the first direction, and configured to press or releases the lever, and
wherein the second parking body rotates in the first direction of rotation as the second conversion gear presses the lever in the first direction.

6. The brake actuator according to claim 5, wherein the first output shaft is misaligned with the second output shaft.

7. The brake actuator according to claim 5, wherein the first conversion gear is a pinion gear, and the second conversion gear is a rack gear.

8. The brake actuator according to claim 5, further comprising a return member connected to the lever and configured to press the lever in the second direction.

9. The brake actuator according to claim 8, wherein the return member is disposed to face the second conversion gear with the lever interposed therebetween.

10. The brake actuator according to claim 8, wherein the return member is configured to be elastically deformable in a direction parallel to the second direction.

11. The brake actuator according to claim 10, wherein the return member is a compression spring.

12. The brake actuator according to claim 4, wherein:
the second parking body is installed to be movable in a longitudinal direction of the rotary shaft; and
when a load acting between one of the extension parts and the latching part increases beyond a set magnitude, the second parking body is moved in a direction of departure parallel to the longitudinal direction of the rotary shaft such that the latching part is separated from the one of the extension parts.

13. The brake actuator according to claim 12, wherein the latching part has a side surface inclined in relation to the longitudinal direction of the rotary shaft.

14. The brake actuator according to claim 12, further comprising a restoration member configured to press the second parking body in a direction opposite to the direction of departure.

15. The brake actuator according to claim 14, wherein the restoration member comprises:
a restoration body disposed to face the second parking body; and
an elastic member configured to be elastically deformable in a direction parallel to the longitudinal direction of the rotary shaft, and having two ends that are in contact with the restoration body and the second parking body, respectively.

16. The brake actuator according to claim 15, wherein the elastic member is a compression spring.

17. A brake apparatus comprising:
a caliper body;
a piston unit movably installed on the caliper body, and configured to come into contact with or separate from a brake pad depending on a direction of movement of the piston unit; and
a brake actuator connected to the piston unit and configured to move the piston unit,
wherein the brake actuator comprises:
a casing;
a first motor installed in the casing;
a transmission gear rotatably installed in the casing and connected to the first motor;
a first parking member configured to rotate together with the transmission gear;
a second motor spaced apart from the first motor;
a second parking member rotatably installed in the casing and configured to selectively limit rotation of the first parking member depending on a direction of rotation of the first parking member; and
a conversion member configured to convert rotational force of the second motor into linear motion to rotate the second parking member.
